(19) United States
(12) Patent Application Publication
(10) Pub. No.: US 2024/0361054 A1
(43) Pub. Date: Oct. 31, 2024

(54) PIPE ARRANGEMENT FOR AN AIR-CONDITIONING DEVICE

(71) Applicant: TI Automotive Technology Center GmbH, Rastatt (DE)

(72) Inventors: Albert BOECKER, Ettlingen (DE); Sebastian BRIXNER, Edingen-Neckarhausen (DE); Werner MERZ, Gaggenau (DE); Gerhard KOLB, St. Leon-Rot (DE); Sandra PILLMANN, Karlsruhe (DE); Christian HENNING, Kehl (DE)

(21) Appl. No.: 18/684,429

(22) PCT Filed: Aug. 18, 2022
(86) PCT No.: PCT/IB2022/057766

§ 371 Date: Feb. 16, 2024

(30) Foreign Application Priority Data
Aug. 18, 2021 (DE) 20 2021 104 430.6

(51) Int. Cl. F25B 41/40; B60H 1/00; F16K 27/00

(52) U.S. Cl. CPC F25B 41/40; F16K 27/003; B60H 1/00571

(57) ABSTRACT

A tube or pipe arrangement for an air-conditioning device, the arrangement including a base body in which several fluid channels and several openings are incorporated. At least one valve and several connections are arranged in the openings. At least one sensor may be arranged in the openings. The base body may have a receptacle for a component of the air-conditioning device.

### RELATED APPLICATIONS

The present disclosure claims priority to and is a national phase application of PCT Application PCT/IB2022/057766, filed Aug. 18, 2022, which claims priority to and the benefit of German Utility Model application No. 202021104430.6, filed Aug. 18, 2021, the entire contents of which is incorporated herein by reference.

### FIELD

The present disclosure relates to a tube or pipe arrangement for an air-conditioning device, comprising a base body in which several fluid channels and several openings are incorporated.

### BACKGROUND

A pipe arrangement with several fluid channels and openings is known, for example, from US 2019/0039440 A1. Such pipe arrangements are preferably used in electromobility applications. There, air-conditioning devices are subjected to particularly high requirements. On the one hand, the installation space is particularly small so that air-conditioning devices must be designed to be especially compact. Furthermore, electric vehicles have several components in addition to the interior that need to be air-conditioned, such as the electric motors, the power electronics, the charging unit and the electric storage cells.

Electric vehicles have only an optimal efficiency in a limited temperature spectrum, so it may be necessary to heat or cool the components connected to the air-conditioning device depending on the climatic conditions and the required electrical power. However, this requires a complex control of the components and an elaborate guidance of the temperature control medium. Accordingly, it is necessary to equip the air-conditioning device with several fluid channels and several valves. From the prior art, it is known to provide a pipe arrangement with a base body in which several fluid channels are incorporated.

### BRIEF SUMMARY

The disclosure provides a pipe arrangement for an air-conditioning device that can be adapted to various air-conditioning tasks in a particularly easy manner.

The tube or pipe arrangement for an air-conditioning device according to the present disclosure comprises a base body in which several fluid channels and several openings are incorporated, wherein at least one valve and several connections are arranged in the openings. Accordingly, the base body has several fluid channels, wherein individual fluid channels are each in connection with at least two openings. It is also conceivable that fluid channels within the base body are in connection with each other. The design of the fluid channels depends on the requirements of the air-conditioning device.

In addition to the valves and connections, it is also conceivable that at least one sensor is arranged in the openings. It is also conceivable that several sensors are arranged in the openings. In particular, pressure sensors, temperature sensors and volume flow sensors can be taken into consideration as sensors.

The valves and connections can be optionally attachable in the openings. This applies equally to the sensors arranged in the openings. Depending on the requirements of the air-conditioning device, individual openings can be equipped with valves and other openings with connections. Sensors can be incorporated into further openings. If a required arrangement of valves, connections and sensors should result in the fact that they do not close all openings, it is conceivable to close the remaining openings with closure elements. The valves can be designed as solenoid valves and release or block the fluid channel. Furthermore, it is conceivable that at least one of the valves is designed as a directional control valve. This makes it not only possible to release or block a fluid channel, but also to divert a fluid from one fluid channel to another fluid channel. It is also conceivable that at least one valve is designed as a pressure relief valve or a check valve.

Depending on the air-conditioning requirements, for example depending on the number of components to be air-conditioned and depending on whether components only need to be cooled or cooled and heated, the openings of the base body can be equipped with valves and connections. In turn, other components can be connected directly to the connections. For example, the connections may comprise a quick connector so that pipes or tubes can be attached to the connections, for instance by latching or screwing.

Preferably, the pipe arrangement comprises at least three valves. Electric vehicles in particular require complex air-conditioning of several components so that the piping system of the air-conditioning device requires several fluid lines with adaptable fluid flows so that the piping arrangement should have at least three valves.

The base body can have a receptacle for a component of the air-conditioning device. In this case, the receptacle can be designed as a holding means and, for example, accommodate a fastening clamp or the like. This allows a component of the air-conditioning device to be attached to the pipe arrangement, resulting in a particularly compact air-conditioning device. It is also conceivable that the receptacle is designed to accommodate several components of the air-conditioning device. According to an advantageous embodiment, the receptacle is designed as a hole into which a thread is incorporated. Furthermore, the outer contour of the base body can be adapted in sections to the component of the air-conditioning device so that the component is held particularly securely and without play on the pipe arrangement.

The base body can be an integral part of the component. In this embodiment, the base body accommodates the component at least partially. This embodiment results in a particularly compact air-conditioning unit with especially short pipelines. A particularly compact embodiment of an air-conditioning device is given if the base body of the pipe arrangement is designed as a housing part of the component. For example, the component may be formed as an accumulator, wherein an opening is made in the base body, wherein the wall of the opening forms a part of the outer wall of the accumulator.

By integrating the component, it is possible to design a particularly compact air-conditioning device with especially short lines. This already applies to the embodiment in which the base body merely forms a receptacle for a component of the air-conditioning device. Overall, thereby, it is particularly advantageous that the quantity of the required temperature control medium, for example the coolant, is reduced. In this context, it is conceivable that the amount of coolant required could be reduced to such an extent that the use of inexpensive and efficient, but flammable coolants such as propane is permissible.

Preferably, the base body is made of metallic material. Especially in connection with the integration of the component, it is advantageous if the base body is designed as a casting. It is also conceivable to design the base body using the forging or milling process. Complex shaping of the base body can also be achieved if the base body is designed as an extrusion part. The use of metallic material also makes the pipe arrangement suitable for air-conditioning devices that involve high working pressures, for example an air-conditioning device with carbon dioxide as temperature control medium. In particular, it is conceivable to form the pipe arrangement from aluminum. However, if there are only minor mechanical requirements, the pipe arrangement can also be formed of plastic.

At least one fluid channel may have a heat exchanger functionality. In particular, it is conceivable to integrate an internal heat exchanger into the pipe arrangement. The heat exchanger functionality can be realized in particular with a base body made of heat-conducting metal. This is particularly advantageous if the pipe arrangement has an accumulator associated with it, which either rests against the outer wall of the base body or is accommodated in the base body.

In this context, the base body can be porous, at least in sections, to provide the heat exchanger functionality. The porous embodiment results in a very greatly increased surface area within the fluid channel, being favorable for the heat exchange. In this context, it is conceivable that adjacent channels between which heat exchange is to take place each have a porous wall. This results in particularly good heat transfer. Thereby, the porous embodiment of the boundary walls of the fluid channels is configured so that there is no exchange of temperature control medium from one channel to the other.

### BRIEF DESCRIPTION OF THE DRAWINGS

Some embodiments of the pipe arrangement according to the present disclosure and of the air-conditioning device according to the present disclosure will be explained in more detail below with the help of the figures. Each show schematically:

FIG. 1 a pipe arrangement in transparent view;

FIG. 2 an air-conditioning device with a pipe arrangement according to FIG. 1;

FIG. 3 another view of the air-conditioning device shown in FIG. 2;

FIG. 4 a pipe arrangement with a receptacle for a component of the air-conditioning device;

FIG. 5 an air-conditioning device with a pipe arrangement according to FIG. 4;

FIG. 6 a sectional view of a base body with porous sections.

### DETAILED DESCRIPTION

The figures show a tube or pipe arrangement 1 for an air-conditioning device 20, wherein the air-conditioning device 20 is in turn part of an electric vehicle. Various components of the electric vehicle, for example the electric energy storage units, the electric motors, the charging unit and the power electronics, as well as the interior of the electric vehicle, are tempered via the air-conditioning device 20.

The pipe arrangement 1 comprises a base body 2 made of metallic material, in this case extruded aluminum. Several fluid channels 3 and several openings 4 are incorporated in the base body. In turn, several valves 5 and connections 6 as well as sensors 7 are arranged in the openings 4. The connections 6 are designed as quick connectors to accommodate pipelines or hoses. The sensors 7 comprise temperature sensors, pressure sensors, and volume flow sensors. The valves 5 are designed as solenoid switching valves. However, depending on the requirements of the pipe arrangement 1, valves 5 in the form of directional control valves, pressure relief valves or check valves can also be used.

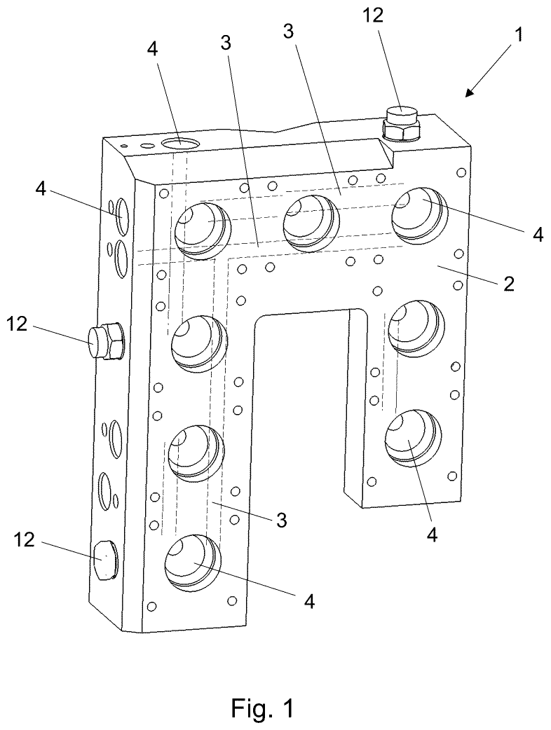

FIG. 1 shows a pipe arrangement 1 with a base body 2 which has several fluid channels 3 and several openings 4. Some openings 4 are closed by closure elements. Valves 5, connections 6, and sensors 7 can be incorporated in further openings 4. The openings 4 are designed as holes in which threads and sealing surfaces are incorporated. The valves 5 and connections 6 can be optionally attached in the openings 4. After complete assembly, some openings 4, which are neither equipped with a valve 5 nor with a connection 6 or a sensor 7, are closed by closure elements 12, which are screwed into the openings 4.

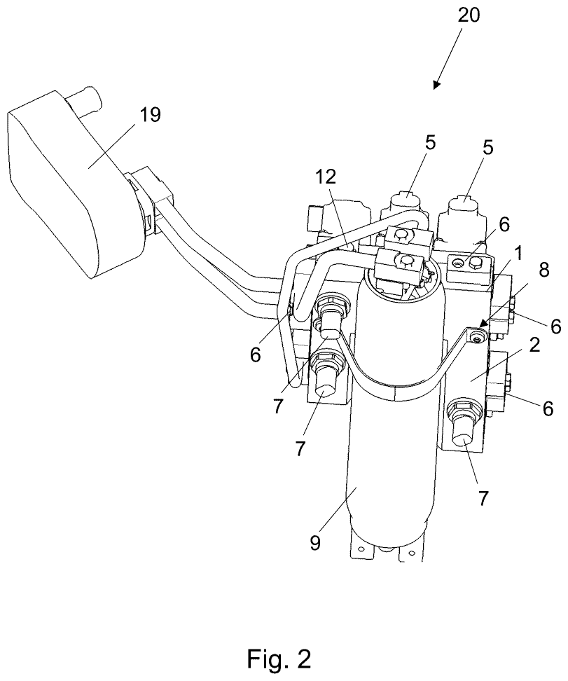

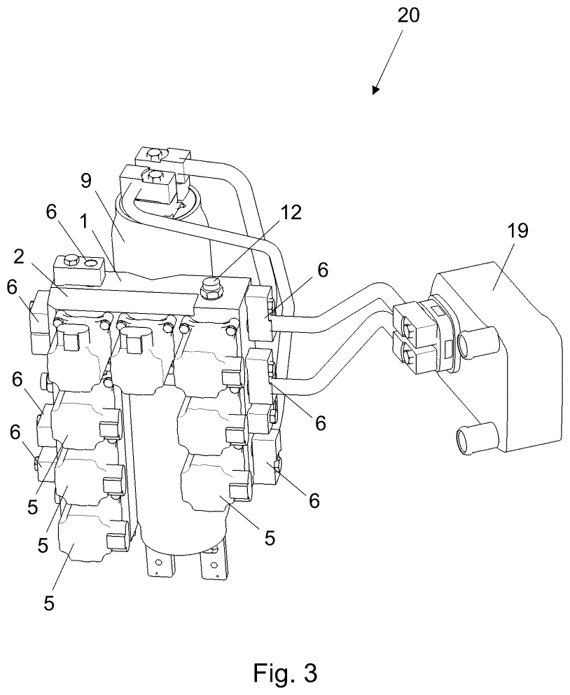

FIG. 2 shows an air-conditioning device 20 with a pipe arrangement 1 according to FIG. 1 in the front view and FIG. 3 shows the air-conditioning device 20 according to FIG. 2 in a rear view. In the present embodiment, eight valves 5 are incorporated in the base body 2, which are in contact with the fluid channels 3 and influence the flow of the temperature control medium flowing in the fluid channels 3. Several pipelines are attached to the connections 6. The air-conditioning device 20 shown in FIGS. 2 and 3 shows, in addition to the pipe arrangement 1, a component 9 in the form of an accumulator, and a heat exchanger 19.

The base body 2 has a receptacle 8 for a component 9 of the air-conditioning device 20, wherein the component 9 is the accumulator in the present case. For this purpose, receptacles 8 in the form of threaded holes are provided in the base body 2 and the component 9 is fastened to the pipe arrangement 1 by means of a fastening clamp.

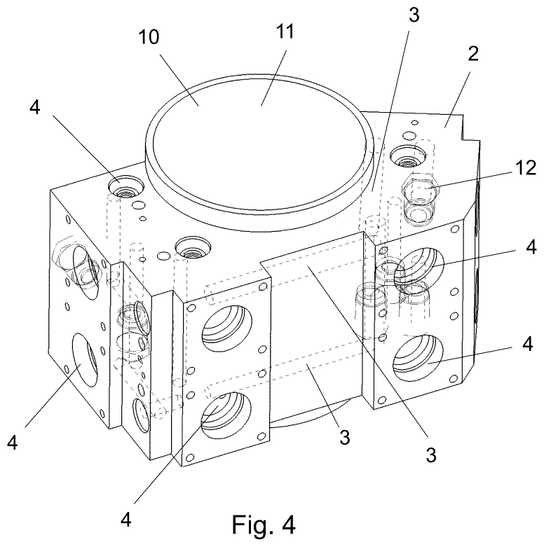

FIG. 4 shows a further embodiment of the pipe arrangement 1, in which the base body 2 is an integral part of the component 9. For this purpose, a recess 11 is made in the base body 2 to accommodate the component 9. In this case, the base body 2 forms a housing part 10 of the component 9. In the present embodiment, the wall of the recess 11 forms a housing part 10 of the component 9 in the form of the outer wall. The base body 2 is made of metallic material, in this case aluminum, and is designed as a casting.

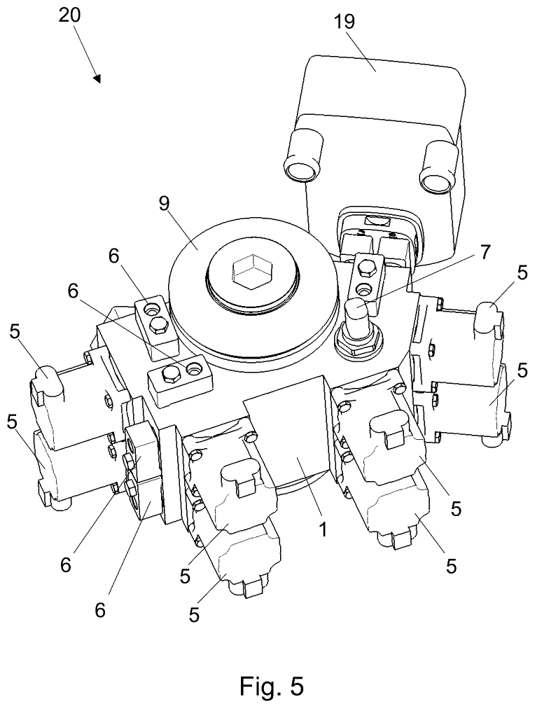

FIG. 5 shows the pipe arrangement 1 shown in FIG. 4, wherein a component 9, in this case an accumulator, is inserted into the recess 11. In doing so, the inner wall of the recess 11 forms a housing part 10 of the component 9. As a result, the component 9 is an integral part of the pipe arrangement 1. Eight valves 5 are incorporated into the openings 4 of the base body 2. Furthermore, the base body 2 is equipped with sensors 7 in the form of temperature sensors, pressure sensors and volume flow sensors. The pipe arrangement 1 is part of an air-conditioning device 20, wherein a heat exchanger 19 is depicted here in addition to the pipe arrangement 1 and the accumulator.

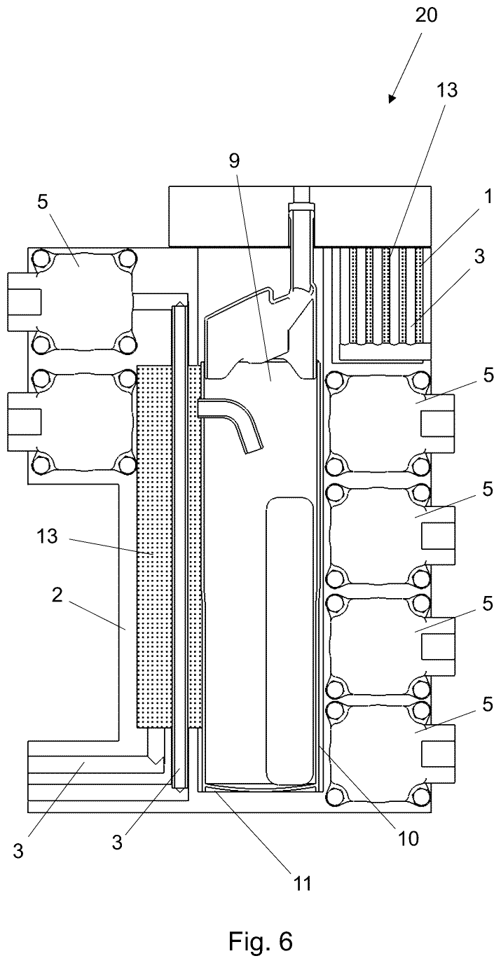

FIG. 6 shows a sectional view of the pipe arrangement 1 shown in FIG. 5. In the present embodiment, the base body 2 is porous in sections 13 to provide a heat exchanger functionality. The porous embodiment of the base body 2 takes place in sections 13, from which fluid channels 3 are formed, so that these have a greatly increased inner surface area in the sections 13. This allows the fluid channels 3 to exchange large amounts of heat, which applies especially to adjacent fluid channels 3. This embodiment results in an internal heat exchanger within the base body 2, wherein the internal heat exchanger is integral with the base body 2. As a result, at least one fluid channel 3 has a heat exchanger functionality.

1. A pipe arrangement for an air-conditioning device, comprising a base body in which several fluid channels and several openings are incorporated, wherein at least one valve and several connections are arranged in the openings.

2. The pipe arrangement according to claim 1, wherein at least one sensor is arranged in the openings.

3. The pipe arrangement according to claim 1, wherein the valves and connections are selectively attachable in the openings.

4. The pipe arrangement according to claim 1, wherein at least three valves are provided.

5. The pipe arrangement according to claim 1, wherein the base body has a receptacle for a component of the air-conditioning device.

6. The pipe arrangement according to claim 5, wherein the base body is an integral part of the component, or the base body is unitarily formed with the component.

7. The pipe arrangement according to claim 5, wherein the base body forms a housing part of the component.

8. The pipe arrangement according to claim 5, wherein the component is formed as an accumulator.

9. The pipe arrangement according to claim 5, wherein the component is formed as a pump or compressor.

10. The pipe arrangement according to claim 1, wherein the base body is formed from metallic material.

11. The pipe arrangement according to claim 1, wherein at least one fluid channel is configured to function as a heat exchanger.

12. The pipe arrangement according to claim 11, wherein the base body is designed to be porous at least in sections in order to provide the heat exchanger functionality.
